(19) United States
(12) Patent Application Publication
(10) Pub. No.: US 2015/0136811 A1
(43) Pub. Date: May 21, 2015

(54) DRAINABLE SYSTEM FOR DISPENSING LIQUID OR PASTY PRODUCT

(71) Applicant: ARCIL, Puiseux Pontoise (FR)

(72) Inventors: Sebastien BOSC, Bondoufle (FR); Paul LE ROI, Ris-Orangis (FR)

(21) Appl. No.: 14/543,941

(22) Filed: Nov. 18, 2014

(30) Foreign Application Priority Data
Nov. 20, 2013 (FR) 13 61384

(51) Int. Cl. B67D 7/58

(52) U.S. Cl. CPC B05B 1/30
USPC 222/380

(57) ABSTRACT

System for dispensing a liquid or pasty product comprising at least one nozzle (6) with a dispensing chamber (85) and at least one ejection duct (91) extending substantially along the axis (60) of the nozzle and in communication with this chamber, and at least one feed duct (7) connected to a metering device and in communication with the dispensing chamber (85) of said at least one nozzle (6), wherein the angle α between the axis (60) of the nozzle and that (70) of the feed duct (7), measured in the clockwise direction, is strictly smaller than 90°.

### FIELD OF INVENTION

The invention relates to a system for dispensing liquid or pasty product.

### BACKGROUND ART

Such a system generally comprises a plurality of nozzles connected to metering devices. These nozzles allow a desired quantity of product to be conveyed into containers such as yoghurt pots.

An example of such a nozzle is illustrated in FIG. 1 which is a view in axial section of a nozzle according to the prior art.

This nozzle 1 comprises a housing 2 comprising a bottom 20 and a side wall 21 and defining a cavity 22 which is open on the opposite side to the bottom 20.

Provided in the side wall 21 is an opening 23 which is connected to a feed duct 3. This duct 3 is connected to the outlet of a liquid or pasty product metering device.

The nozzle 1 also comprises a nozzle body 4 which penetrates the housing 2, through an opening 24 made in the bottom 20. Sealing between the housing 2 and the nozzle body 4 is provided by a gasket 40.

The body 4 defines with the housing 2 a dispensing chamber 25 which is in communication with the duct 3.

Passing through the nozzle body 4 are a plurality of ejection ducts 41 which run parallel to the axis 10 of the nozzle and which in this instance are distributed around the periphery of the body 4. All of these ejection ducts are through-ducts.

The nozzle 1 finally comprises a shut-off membrane 26 the annular edge 27 of which is held between a support plate 5 and the top face 28 of the side wall 21 of the housing 2.

Gaskets 40 and 46 are also provided between the body 4 and the side wall 21 of the housing 2.

Thus, passages 47 are created in the upper part of the body 4 between the dispensing chamber 25 and the top face 42 of the nozzle body 4. These allow the supply duct 3 to be connected to the space 48 created between the membrane 26 and the top face 42 of the nozzle body 4.

Thus, a liquid or pasty product coming from a metering device is conveyed to the nozzle 1 by the feed pipe 3 and enters the dispensing chamber 25, the passages 47, the space 48 and then the ejection ducts 41. The latter allow the product to be conveyed as far as the ejection tubes 43 via which the product emerges and which are provided on the lower face 44 of the nozzle body.

FIG. 1 shows that the support plate 5 is pierced with ducts 50 which can alternately be connected to a source of compressed air or to the atmosphere.

FIG. 1 illustrates the relative position of the membrane 26 and of the plate 5 when the duct 50 is connected to the atmosphere. The membrane 26 is therefore in contact with the plate 5 when a product flows under pressure through the dispensing nozzle 1 from the feed duct 3 to the ejection tubes 43.

When a supply of compressed air is present, the membrane 5 is pressed firmly against the upper face 42 of the nozzle body 4 and closes off the inlet orifices 45 of the ejection ducts 41 which open onto the top face.

Nozzles of this type operate satisfactorily.

However, when the nozzles are intended for food or cosmetic applications, they need to meet specific requirements such as, for example, defined by European (EC) Regulation 1935/2004 or American Standard 3-A-SSI.

These requirements notably stipulate that the entire dispensing system, namely both the nozzles and the feed ducts be able to be emptied or drained completely following normal use or cleaning.

Now, the nozzle of the type illustrated in FIG. 1 does not meet this requirement insofar as it comprises dead volumes which are always filled with the product being dispensed or with cleaning solution. These dead volumes are situated notably at the junction between the feed duct and the dispensing chamber 25.

The invention seeks to address these disadvantages by proposing a liquid or pasty product dispensing system that can be completely drained and thus has no remaining volume filled with the product dispensed or with a cleaning solution after the nozzle has been used or cleaned.

### SUMMARY OF THE INVENTION

Thus the invention relates to a system for dispensing a liquid or pasty product comprising at least one nozzle with a dispensing chamber and at least one ejection duct extending substantially along the axis of the nozzle and in communication with this chamber, and at least one feed duct connected to a metering device and in communication with the dispensing chamber of said at least one nozzle.

According to the invention, the angle α between the axis of the nozzle and that of the feed duct, measured in the clockwise direction, is strictly smaller than 90°.

For preference, this angle α is comprised between 80° and 90° and notably equal to 88.5°.

For preference, the bottom of the dispensing chamber defines a curve which is situated at the same level as or above the low point of the duct.

In a first alternative form, said curve defines a plane substantially perpendicular to the axis of the nozzle.

In a second alterative form, said curve defines a plane making an angle β with the axis of the nozzle which is strictly smaller than 90°, measured in the clockwise direction from the axis of the nozzle to said plane.

Advantageously, the dispensing system is associated with at least one metering device situated under said at least one nozzle.

### BRIEF DESCRIPTION OF THE DRAWINGS

The invention will be better understood and further objects, advantages and features thereof will become more clearly apparent in reading the following description which is given with reference to the attached drawings in which:

FIG. 1 is a view in axial section of a nozzle according to the prior art, and

FIG. 2 is a view in axial section of one embodiment illustrating a dispensing system according to the invention, and

FIG. 3 is a partial view in axial section illustrating an alternative form of the dispensing system according to FIG. 2.

Elements common to the two figures will be illustrated using the same references.

### DETAILED DESCRIPTION OF THE INVENTION

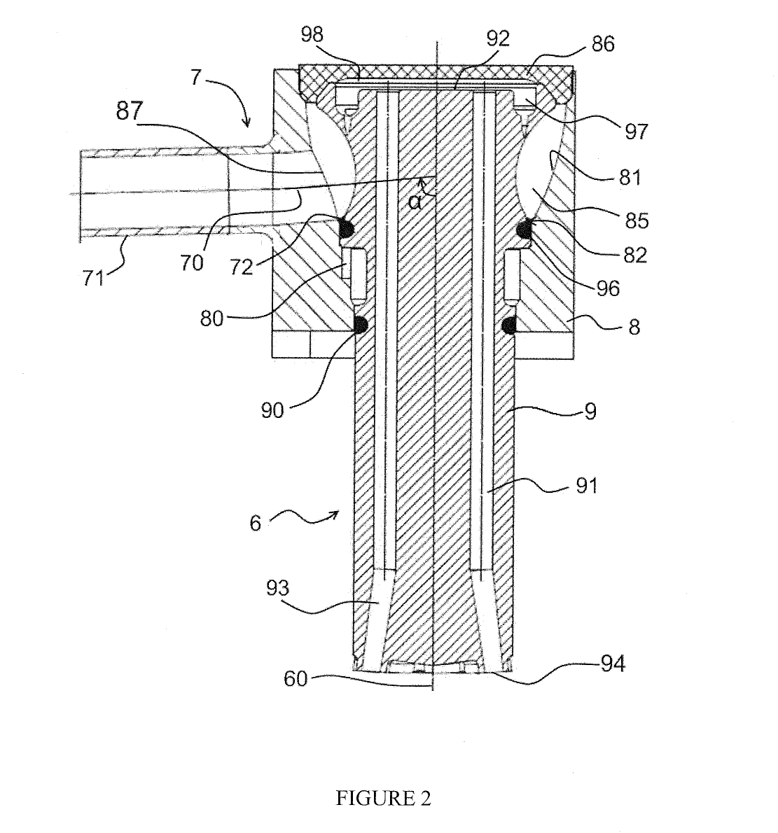

FIG. 2 illustrates a product dispensing system comprising a nozzle 6 and a feed duct 7.

In practice, a dispensing system comprises a plurality of nozzles but only one can be seen in FIG. 2.

The nozzle 6 comprises a housing 8 in which a cavity 80 is formed. The nozzle body 9 is partially inserted into this cavity 80.

The nozzle body could be of one piece with the housing 8.

In the example illustrated in FIG. 2, the duct 7 is also formed in the housing 8 of the nozzle.

The nozzle body 9 thus, with the wall 81 of this cavity, defines a dispensing chamber 85 which communicates with the duct 7 through the opening 87.

In the region of this opening 87, the duct 7 has a low point referenced 72.

This then is the point of the duct 7 that coincides with the cavity 80 and is lowest down with respect to the axis 60 of the nozzle, namely furthest away from the top face 92 of the nozzle body.

In the example illustrated in FIG. 2, the chamber 85 has a shape of revolution about the axis 60 of the nozzle 6.

Moreover, the connection between the chamber 85 and the duct 7 is designed in such a way that there is no dead volume present between the chamber and the duct.

In other words, the bottom of the chamber 85 defines a curve 82 which is situated at the same level as the low point 72 of the duct 7.

In this particular instance this curve 82 is a circle situated in a plane substantially perpendicular to the axis 60.

The curve 82 could also be situated above the low point 72.

Gaskets 90 and 96 provide sealing between the body 9 and the cavity 80 formed in the housing 8. These gaskets are situated below the curve 82.

The nozzle body 9 has passing through it a plurality of ejection ducts 91 (two have been depicted in FIG. 2). Each duct 91 passes through the nozzle body 9 from the top face 92 thereof to the lower face 94 thereof and runs substantially along the axis 60 of the nozzle.

A membrane 86 can be used to close off the ejection ducts 91, notably under the effect of compressed air. The means that allow the ducts 91 to be closed off using the membrane have not been illustrated in FIG. 2.

A space 98 is created between the membrane 86 and the top face 92 of the nozzle body and passages 97 are created between the dispensing chamber 85 and this space 98.

In normal nozzle operation, a product coming from the outlet duct 71 of a metering device flows through the nozzle 6, from the feed duct 7 to the ejection tube 93 of each ejection duct 91.

In general, the dispensing system may comprise one metering device per nozzle, one metering device associated with several nozzles or several metering devices per nozzle.

The product is thus conveyed from the feed duct 7 to the dispensing chamber 85 and, by the passages 97 and the space 98, as far as the ejection ducts 91.

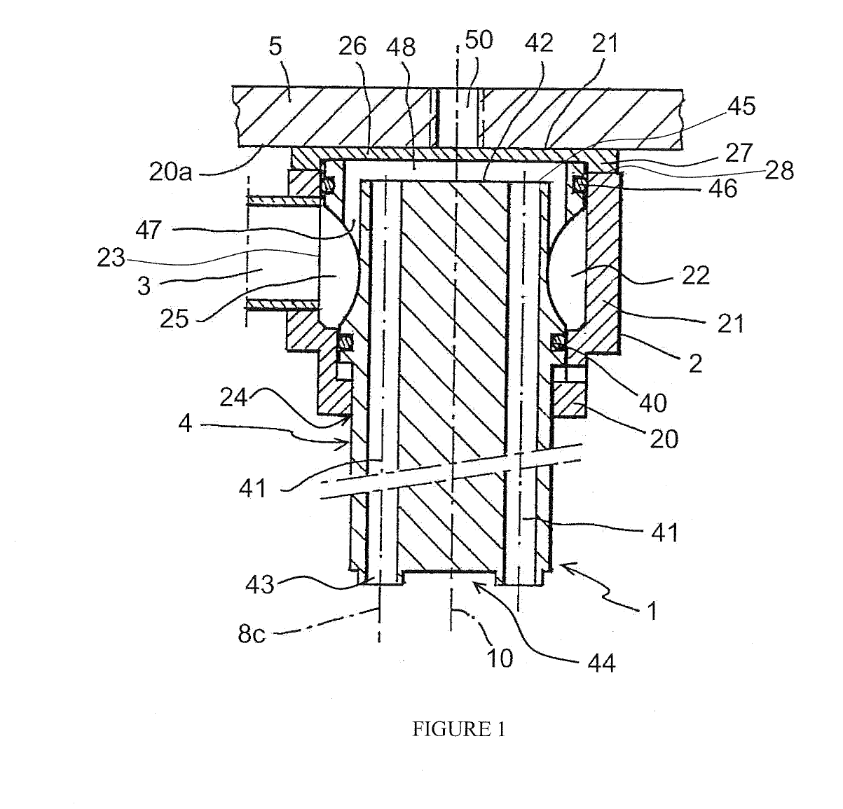

FIG. 2 shows that, unlike the duct 3 of the nozzle of the prior art illustrated in FIG. 1, the duct 7 is not perpendicular to the axis 60 of the nozzle.

On the contrary, the angle α between the axis 60 and the axis 70 of the supply duct is an acute angle. The angle α is measured in the clockwise direction, i.e. from the axis 60 to the axis 70.

The angle α is preferably comprised between 80° and 90° and notably equal to 88.5°.

Thus, after the nozzle has been used, the dispensed product has mainly flowed out through the ejection ducts 91.

Furthermore, the remaining product drops under gravity into the dispensing chamber 85 and from there to outside the nozzle, via the duct 7.

Specifically, the angular positioning of the duct 7 with respect to the axis of the nozzle causes the products present in the duct 7 to move away from the dispensing chamber 85, under the effect of gravity.

Moreover, when the nozzle is cleaned, the cleaning liquid passes through the nozzle from the dispensing chamber 85 to the ejection tube 94 of the duct 91. The majority of the cleaning liquid is thus discharged from the nozzle.

Any remaining liquid moves, under the effect of gravity, from the dispensing chamber 85 to the duct 7.

Thus, no proportion of the cleaning liquid is liable to remain in the nozzle. The nozzle can therefore be completely drained.

This result is also strengthened by the absence of dead volume between the duct and the dispensing chamber, thanks to the fact that the bottom of the dispensing chamber 85 is positioned level with or above the low point 72 of the duct 7.

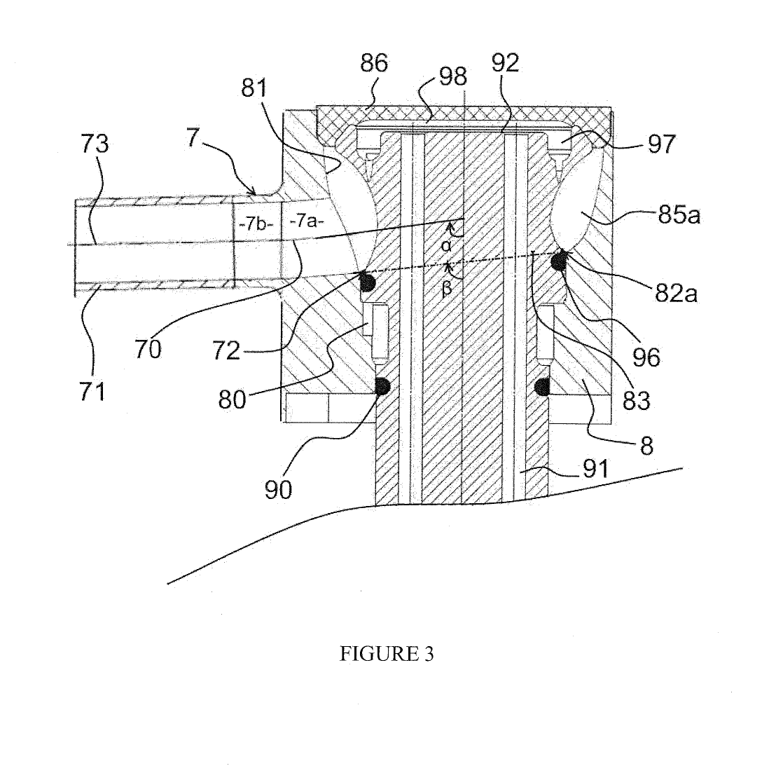

Reference is now made to FIG. 3 which illustrates an alternative form of the embodiment of the dispensing chamber.

In this alternative form, the bottom of the chamber 85a defines a curve 82a which is inclined with respect to the axis 60 toward the duct 7.

This curve 82a in this instance is a circle inclined by an angle β which is strictly smaller than 90°, the angle β being measured in the clockwise direction from the axis 60 to the axis 83.

This angle β is preferably comprised between 80° and 90° and notably equal to 88.5°.

The axis 83 connects two points situated in the bottom of the chamber 85a, the first being the lowest point of the bottom of the chamber (situated on the same side as the duct 7) and the second being the highest point (diametrically opposite the first point). This axis belongs to the plane defined by the curve 82a.

In the example illustrated in FIG. 3, the first point is level with the low point 72 of the duct 7.

The first point on the curve 82a could also be situated above the low point 72 of the duct.

The second point is situated slightly above the first point, namely closer to the upper face 92 of the nozzle body.

The inclination of the chamber 85a makes it easier for any remaining product or cleaning liquid to pass from the chamber to the duct 7.

In the examples described hereinabove, the curves 82 and 82a are circles but the invention is not restricted to that embodiment.

With the dispensing system according to the invention, the emptying of the nozzle takes place not only via the ejection ducts thereof but also via the duct that is normally used to feed the nozzle with product or with cleaning liquid.

Thus, the dispensing system according to the invention allows the conventional drainage route to be supplemented by an additional route which is in principle used for admitting product or cleaning liquid.

In practice, the metering device will be situated under the nozzle 6 or, more specifically, under the housing of the nozzle so as to ensure that the duct 71 contributes to the draining of the product or of the cleaning liquid.

In any event, it is appropriate for the outlet duct 71 of the metering device also to be inclined, so that the angle between the axis 60 of the nozzle and that 73 of the duct 71, measured in the clockwise direction, is strictly smaller than 90°.

FIGS. 2 and 3 show a particular embodiment in which the feed duct 70 is slightly bent.

That part 7a of the duct 7 that opens into the chamber 85a has the axis 70 as its axis, whereas the part 7b that connects the ducts 7 and 71 has the axis 73 of the outlet duct 71 as its axis.

The reference signs inserted after the technical features given in the claims are there solely to make the latter easier to understand and do not in any way restrict the scope thereof.

1. A system for dispensing a liquid or pasty product comprising at least one nozzle (6) with a dispensing chamber (85, 85a) and at least one ejection duct (91) extending substantially along the axis (60) of the nozzle and in communication with this chamber, and at least one feed duct (7) connected to a metering device and in communication with the dispensing chamber (85, 85a) of said at least one nozzle (6), wherein the angle α between the axis (60) of the nozzle and that (70) of the feed duct (7), measured in the clockwise direction, is strictly smaller than 90°.

2. The system as claimed in claim 1, wherein this angle α is comprised between 80° and 90° and notably equal to 88.5.

3. The system as claimed in claim 1, wherein the bottom of the dispensing chamber (85, 85a) defines a curve (82, 82a) which is situated at the same level as or above the low point (72) of the duct (7).

4. The system as claimed in claim 3, wherein said curve (82) defines a plane substantially perpendicular to the axis (60) of the nozzle.

5. The system as claimed in claim 3, wherein said curve (82a) defines a plane making an angle β with the axis (60) of the nozzle which is strictly smaller than 90°, measured in the clockwise direction from the axis (60) to said plane.

6. The system as claimed in claim 1, and which is associated with at least one metering device situated under said at least one nozzle (6).
